(19) United States
(12) Patent Application Publication
(10) Pub. No.: US 2013/0160440 A1
(43) Pub. Date: Jun. 27, 2013

(54) Hydraulic System with Pilot Circuit Power Reclamation

(71) Applicant: David E. Ault, Peoria, IL (US)

(72) Inventor: David E. Ault, Peoria, IL (US)

(73) Assignee: Caterpillar Inc., Peoria, IL (US)

(21) Appl. No.: 13/336,395

(22) Filed: Dec. 23, 2011

(51) Int. Cl. E02F 9/22; F15B 1/027

(52) U.S. Cl. 60/413

(57) ABSTRACT

A hydraulic system includes a fluid source, a metering valve, an actuator, and a power reclamation assembly. The metering valve includes a standby position, and an actuation position different than the standby position. The metering valve fluidly connects the actuator to the fluid source when in the actuation position. The metering valve fluidly connects the power reclamation assembly to the fluid source when the metering valve is in the standby position.

### TECHNICAL FIELD

The present disclosure relates generally to hydraulic circuits with power reclamation functionality. Specifically, an embodiment of the present invention relates to a hydraulic circuit with standby power reclamation.

### BACKGROUND

Operators of machines with hydraulically powered and/or controlled work implement systems desire responsiveness from the work implement system when giving a command. Owners and operators of machinery also desire the work implement system to operate efficiently to reduce operating costs. Different types of hydraulic actuator systems to control work implement systems are readily known to those trained in the art.

One type features a fluid source that provides a constant flow of pressurized fluid to one or more metering valves. When no operator actuation command is issued, the metering valve directs the flow to the fluid tank through a standby circuit. When an operator actuation command is issued, the metering valve directs fluid flow towards a hydraulic actuator (motor, cylinder, etc.). Operators may appreciate the responsiveness of this type of hydraulic circuit, but the circuit may be less efficient and more costly to operate than other types of hydraulic circuits, as energy is consumed flowing pressurized oil with no actuator motion.

A second type of hydraulic actuator circuit features a fluid source that provides flow rate proportional to an operator command. When no command is issued, the metering valve is closed and a small amount of flow is provided to lubricate and flush the hydraulic circuit. When a command is issued, the metering valve directs the flow toward a hydraulic actuator (motor, cylinder, etc.) while the fluid source increases the flow rate. Although this second type of hydraulic circuit may be more efficient and thus less costly to operate, operators may find it less responsive to commands.

WIPO publication WO 2010/123378 A1 discloses an open hydraulic system (or an open system embedded in a closed system) particularly adapted to power cranes and winches. The system includes an oil tank, a hydraulic fluid source driven by a drive motor via a shaft, a control valve, a driven component adapted to drive a load, and a load holding valve which is connected across the driven component. In addition, the system includes a hydraulic recovery motor mounted on the shaft from the drive motor and the fluid source. When a load is released, potential energy and positional energy released by the load may drive the recovery motor which in its turn drives the drive motor as a generator. In this way, the potential energy in the load may be recovered.

### SUMMARY OF THE INVENTION

One aspect of the disclosure includes a hydraulic system including a fluid source, a metering valve, an actuator, and a power reclamation assembly. The metering valve includes a standby position, and an actuation position different than the standby position. The metering valve fluidly connects the actuator to the fluid source when in the actuation position. The metering valve fluidly connects the power reclamation assembly to the fluid source when the metering valve is in the standby position.

Another aspect of the disclosure includes a hydraulic system including a fluid source, multiple metering valves, multiple actuators, and a power reclamation assembly. Each metering valve includes a standby position, and an actuation position different than the standby position. Each actuator is associated with one of the multiple metering valves which fluidly connects the actuator with the fluid source when the associated metering valve is in the actuation position. The power reclamation assembly is fluidly connected to the fluid source when at least one of the multiple metering valves is in the standby position.

Another aspect of the disclosure includes a machine including an engine, an implement, a fluid source, a fluid tank, a metering valve, an actuator, and a power reclamation assembly. The fluid source is driven by the engine. The metering valve includes a standby position and an actuation position different than the standby position. The actuator is operably connected to the implement. The metering valve fluidly connects the actuator to the fluid source and the fluid tank when in the actuation position. The power reclamation assembly includes a power source which selectively drives the engine. The metering valve fluidly connects the power reclamation assembly to the fluid source when in the standby position.

Another aspect of the disclosure includes an excavator including a body, a base, a swing motor, an engine, a boom, a stick, a bucket, a fluid source, a fluid tank, a power source, multiple metering valves, multiple actuator circuits, and a power reclamation assembly. The swing motor rotates the body in relation to the base. The engine drives the fluid source. Each metering valve includes a standby position and an actuation position different than the standby position. Each actuator circuit includes an actuator operatively connected to one of the swing motor, the boom, the stick, or the bucket. Each of the actuators is associated with one of the metering valves which fluidly connects the actuator with the fluid source and the fluid tank when in the actuation position. The power reclamation assembly includes a power source which selectively drives the engine. The power reclamation assembly is fluidly connected to the fluid source when at least one of the multiple metering valves is in the standby position.

### BRIEF DESCRIPTION OF THE DRAWINGS

FIG. 1 is a pictorial illustration of an exemplary machine.

FIG. 2 is a schematic illustration of an exemplary hydraulic system including an exemplary power reclamation assembly.

FIG. 3 is a schematic illustration of another exemplary power reclamation assembly.

FIG. 4 is a schematic illustration of another exemplary power reclamation assembly.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

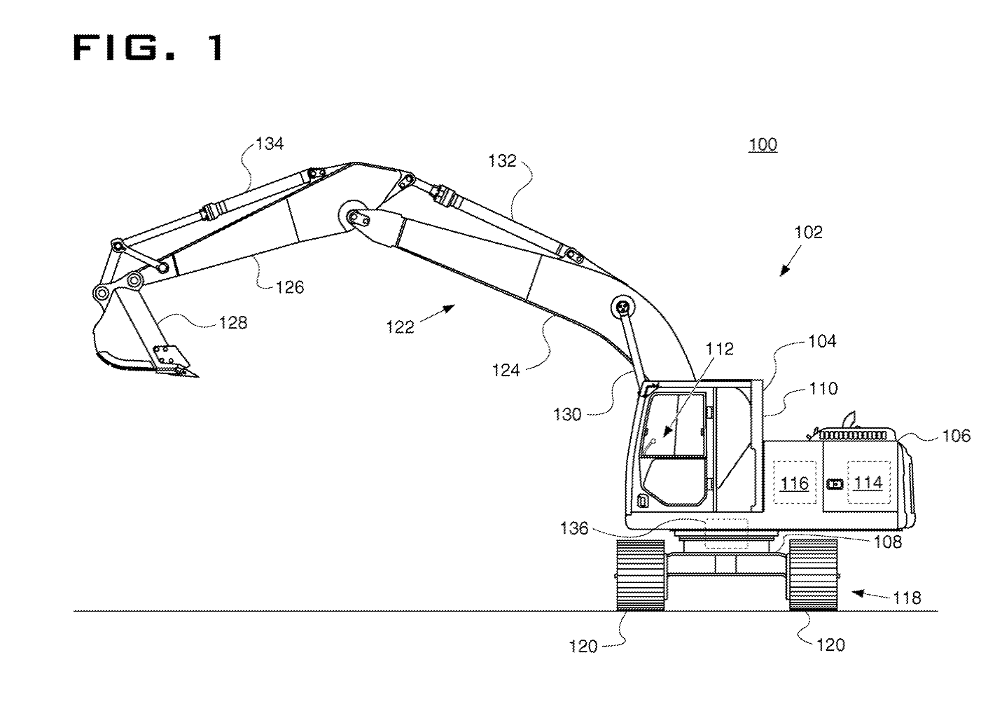

Referring now to FIG. 1, an exemplary embodiment of machine 100 is illustrated. In the embodiment illustrated, the machine 100 is a vehicle 102, and in particular an excavator 104. In other embodiments, the machine 100 may include any system or device for doing work with hydraulically powered work implements or systems that would be known to an ordinary person skilled in the art now or in the future.

The vehicle 104 may include but is not limited to vehicles that perform some type of operation associated with a particular industry such as mining, construction, farming, transportation, etc. and operate between or within work environments (e.g. construction site, mine site, power plants, on-highway applications, marine applications, etc.). Non-limiting examples of vehicle 104 include cranes, earthmoving vehicles, mining vehicles, backhoes, loaders, material handling equipment, dredgers, and farming equipment.

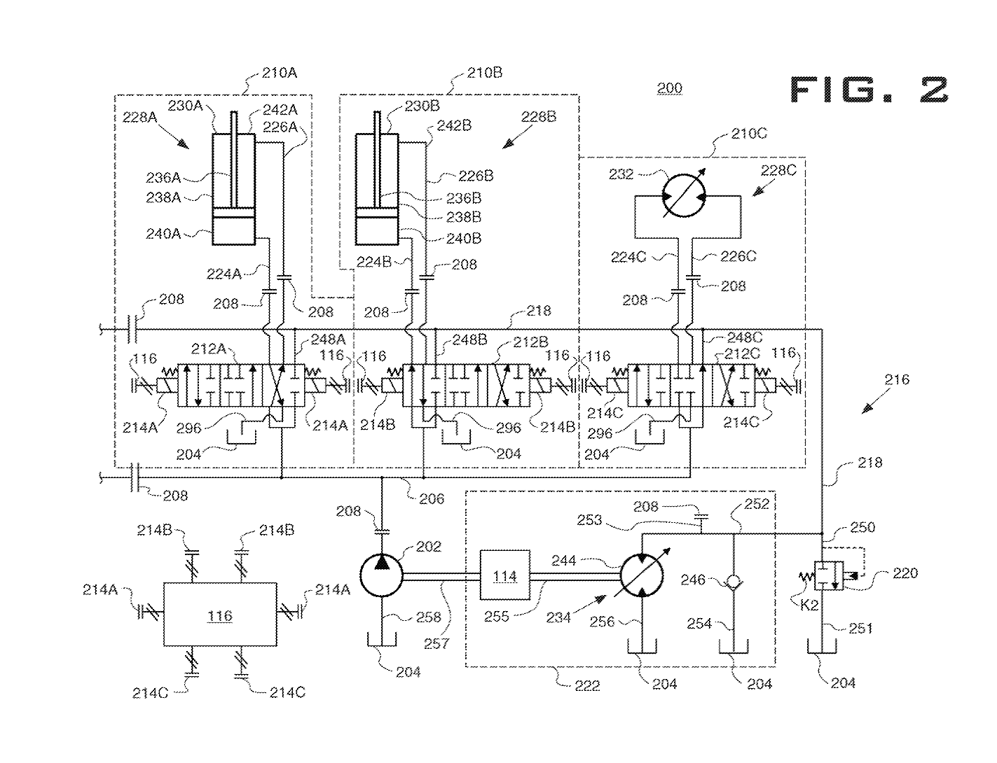

The excavator 104 includes a body 106, a base 108, and a work implement system 122. A swing motor 136 rotates the machine body 106 in relation to the base 108. An engine 114, located in the body 106, powers a drive system 118 to move the excavator 104 on tracks 120. The engine 114 powers a hydraulic system 200 (described in relation to FIG. 2) to actuate the work implement system 122 to do work.

The body 106 includes a cab 110 providing a place for an operator to control the excavator 104 through an operator interface 112. A controller 116, located in the body, executes code and generates command signals in response to operator commands through the operator interface 112 as would be known by an ordinary person skilled in the art now or in the future.

The controller 116 may include a processor (not shown) and a memory component (not shown). The processor may include microprocessors or other processors as known in the art. In some embodiments the processor may include multiple processors. The memory component may include any form of computer-readable media which would be known to an ordinary person skilled in the art now or in the future. The memory component may include multiple memory components.

The controller 116 is illustrated enclosed in a single housing. In alternative embodiments, the controller 116 may include a plurality of components operably connected and enclosed in a plurality of housings. The controller 116 is illustrated located on-board the machine. In other embodiments, the controller 116 may be located off-board or remotely.

The controller 116 is communicatively connected to the operator interface 112 to receive operator command signals, and operatively connected to hydraulic valves (shown in relation to FIG. 2) to control movement of the work implement system 122.

The work implement system 122 on the excavator 106 includes a boom 124, a stick 126, a bucket 128, at least one boom cylinder assembly 130, a stick cylinder assembly 132, and a bucket implement cylinder assembly 134. An operator may command the work implement system 122 to dig earth, or other material at a worksite, with the bucket 128, through the operator interface 112. The commands are transmitted to the controller 112. In response to the operator commands, the controller 112 executes code and generates commands to actuate the swing motor 136, the boom cylinder assembly 130, the stick cylinder assembly 132, and the bucket implement cylinder assembly 134, to rotate the body 106, and move the boom 124, the stick 126, the bucket 128 to perform the operator commanded function.

Referring now to FIG. 2, an exemplary embodiment of a hydraulic system 200 is disclosed. The hydraulic system 200 includes a fluid source 202, metering valves 212, actuators 228, and a power reclamation assembly 222. In the illustrated embodiment, each metering valves 212 include a standby position (shown in relation to metering valve 212C), and 2 actuation positions (shown in relation to metering valves 212A and 212B). For each metering valve 212 illustrated, both actuation positions are different from the standby position. Each actuator 228 illustrated is associated with one of the metering valves 212. Each metering valve 212 fluidly connects the associated actuator 228 with the fluid source 202 when that metering valve 212 is in one of the actuation positions. When any of the illustrated metering valves 212 are in a standby position, that metering valve 212 fluidly connects the power reclamation assembly with the fluid source 202.

In the illustrated embodiment, standby circuit 216 fluidly connects the power reclamation assembly 222 with the fluid source 202 when any of the metering valves 212 are in the standby position. Power reclamation assembly 222 includes a power source 234 which may be driven or charged by pressurized fluid from the standby circuit 216 when any of the metering valves 212 are in the standby position.

In the embodiment illustrated, fluid source 202 includes a fixed displacement pump driven mechanically by the engine 114 through mechanical linkage 257. For example, fluid source 202 may be gear driven or belt driven by engine 114 power output. In another exemplary embodiment, fluid source 202 may be electrically driven by a generator/motor combination driven by engine 114. In another exemplary embodiment, fluid source 202 may include any other type of pump known by an ordinary person skilled in the art now or in the future.

When fluid source 202 is operating, fluid flows from a fluid tank 204, through fluid conduit 258, to fluid source 202. Fluid source 202 pressurizes the fluid and fluid flows through fluid conduit 206, to two ports on each metering valve 212. The hydraulic system 200 may include additional elements 208, as illustrated by the two parallel lines, between fluid source 202 and metering valves 212. For example, pressure relief valves, check valves, or other protective devices, may be included to protect fluid source 202 and other hydraulic system 200 components as would be known to an ordinary person skilled in the art now or in the future.

In the embodiment illustrated, the hydraulic system 200 includes actuating circuits 210A, 210B, and 210C. Although three actuating circuits are shown, in other embodiments, hydraulic system 200 may include fewer or more actuating circuits 210. This is illustrated by the additional element symbol 208 and open end on fluid conduit 206, standby fluid conduit 218, and return fluid conduit 296 For example, in the excavator 104 embodiment, illustrated in relation to FIG. 1, hydraulic system 200 includes an actuator circuit 210 for each of the boom cylinder assembly 130, the stick cylinder assembly 132, the bucket cylinder assembly 134, the swing motor 136, a right track motor (not shown), and a left track motor (not shown). In another non-limiting example, a tracker dozer (not shown) may include actuator circuits for hydraulic cylinder assemblies which tilt, lift and lower a blade, and for track motors.

Each actuating circuit 210 includes an actuator 228 and a metering valve 212. In actuating circuit 210A, actuator 228A includes hydraulic cylinder assembly 230A. In actuating circuit 210B, actuator 228B includes hydraulic cylinder assembly 230B. In actuating circuit 210C, actuator 228C includes hydraulic motor 232. These are exemplary, just as the number of actuating circuits 210 is exemplary. In other embodiments, actuator 228 may include any hydraulically powered actuator that would be known by an ordinary person skilled in the art now or in the future.

The hydraulic cylinder assemblies 230 include a rod 236, and a cylinder 238. The rod 236 extends from and retracts into the cylinder 238 as is known by ordinary persons skilled in the art. The rod 236 includes a piston (not numbered) operable to divide the inside of the cylinder 238 into a head chamber 240, and a rod chamber 242. As pressurized fluid flows into the head chamber 240, the rod 236 extends from the cylinder 238, and fluid flows out of the rod chamber 242. As pressurized fluid flows into the rod chamber 242, the rod 236 retracts into the cylinder 238, and fluid flows out of the head chamber 240. In an excavator 104 embodiment, the rod 236 may be operably connected to move the boom 124, the stick 126, or the bucket 128. As the rod 236 extends from and retracts into the cylinder 238 on each hydraulic cylinder assembly 230 (corresponding to 130, 132, and 134 in FIG. 1), the work implement system 122 operates to dig earth with the bucket 128.

Hydraulic motor 232 is illustrated as a variable displacement hydraulic motor, but may, in other embodiments, include other types of motors such as a fixed displacement hydraulic motor. Motor 232 may include a rotary-type or piston-type hydraulic motor movable by an imbalance of pressure acting on a driven element (not shown), for example, an impeller or a piston. Pressurized fluid directed into one side of the driven element of motor 232, and the draining of fluid from an opposing side of the driven element, creates a pressure differential across the driven element that causes the driven element to move or rotate. The direction and rate of fluid flow through motor 232, and the pressure differential determines the rotational direction, speed, and torque of motor 232. In an excavator embodiment, motor 232 may include the swing motor 136, or a track motor to drive one or both of tracks 120 illustrated in FIG. 1.

Each metering valve 212 illustrated includes a three position solenoid actuated directional valve, spring loaded to the standby position. Each metering valve 212 selectively connects actuator 228 to the fluid source 202. Each metering valve 212 also selectively connects standby circuit 216 with fluid source 202. Fluid conduit 206 connects fluid source 202 to metering valve 212 at two ports. Return fluid conduit 296 connects the fluid tank 204 with metering valves 212.

Metering valves 212 include at least one actuating position. In the illustrated embodiment, metering valves 212 include two actuating positions. Metering valves 212 are communicatively connected with the controller 116. Electrical current, selectively directed to the solenoids of the metering valves 212 by the controller 116 as a function of operator commands, applies force against the spring biasing to move the metering valves 212 to one of the actuating positions. For exemplary purposes, each metering valve 212A, 212B, 212C is illustrated in a different position. Metering valve 212A is illustrated in one of the actuating positions. Metering valve 212B is illustrated in another actuating position. Metering valve 212C is illustrated in the standby position.

Referring now to the operation of actuation circuit 210A and metering valve 212A; fluid conduit 224A connects the head chamber 240A with a port of metering valve 212A. Fluid conduit 226A connects the rod chamber 242A with a port of metering valve 212A. Actuator circuit 210A may include additional elements 208 such as pressure relief or regenerative cross-over circuits. When metering valve 212A is in the actuating position illustrated, fluid flows from the tank 204, through fluid conduit 258 to fluid source 202, where it is pressurized. Pressurized fluid then flows through fluid conduit 206, through metering valve 212A, through fluid conduit 226A, and to the rod chamber 242A. The pressurized fluid pushes against the rod 236A piston, retracting the rod 236A into the cylinder 238A. As the rod 236A retracts into cylinder 238A, fluid from the head chamber 240A is pushed through fluid conduit 224A, through metering valve 212A, through conduit 296, and to fluid tank 204.

When metering valve 212A is in the second actuating position, illustrated in relation to metering valve 212B, fluid flows from the tank 204, through fluid conduit 258 to fluid source 202, where it is pressurized. Pressurized fluid then flows through fluid conduit 206, through metering valve 212A, through fluid conduit 224A, and to the head chamber 240A. The pressurized fluid pushes against the rod 236A piston, extending the rod 236A from the cylinder 238A. As the rod 236A extends from cylinder 238A, fluid from the rod chamber 242A is pushed through fluid conduit 226A, through metering valve 212A, through conduit 296, and to fluid tank 204.

When metering valve 212A is in the standby position, illustrated in relation to metering valve 212C, fluid flows from the tank 204, through fluid conduit 258 to fluid source 202, where it is pressurized. Pressurized fluid then flows through fluid conduit 206, through metering valve 212A, and to standby fluid conduit 218 of the standby circuit 216. The pressurized fluid flows from standby fluid conduit 218, through fluid conduit 250 to pressure relief valve 220; and from standby fluid conduit 218, through fluid conduit 252 to power reclamation assembly 222.

Referring now to the operation of actuation circuit 210B and metering valve 210B; fluid conduit 224B connects the head chamber 240B with a port of metering valve 212B. Fluid conduit 226B connects the rod chamber 242B with a port of metering valve 212B. Actuator circuit 210B may include additional elements 208 such as pressure relief or regenerative cross-over circuits. In the embodiment illustrated, metering valve 212B connects actuator circuit 210B, fluid source 202, standby circuit 216, and power reclamation assembly 222 in the same manner as described above in relation to metering valve 212A.

Referring now to the operation of actuation circuit 210C and metering valve 210C, pump/motor 232 includes a first port and a second port. Fluid conduit 224C connects the first port with a port of metering valve 212C. Fluid conduit 226C connects the second port with a port of metering valve 212C. Actuator circuit 210C may include additional elements 208 such as pressure relief or regenerative cross-over circuits.

When metering valve 212C is in one of the actuating positions, as illustrated in relation to metering valve 212A, fluid flows from the tank 204, through fluid conduit 258 to fluid source 202, where it is pressurized. Pressurized fluid then flows through fluid conduit 206, through metering valve 212C, through fluid conduit 226C, and into the first port of motor 232. The pressurized fluid drives motor 232, rotating an output shaft in a direction determined by the fluid flow direction and the position of the motor 232 swashplate. Fluid is pushed out of the second port of motor 232 through fluid conduit 224C, through metering valve 212C, through conduit 296, and to fluid tank 204.

When metering valve 212C is in the second actuating position, illustrated in relation to metering valve 212B, fluid flows from the tank 204, through fluid conduit 258 to fluid source 202, where it is pressurized. Pressurized fluid then flows through fluid conduit 206, through metering valve 212C, through fluid conduit 224C, and into the second port of motor 232. The pressurized fluid drives motor 232, rotating an output shaft in a direction determined by the fluid flow direction and the position of the motor 232 swashplate. Fluid is pushed out of the first port of motor 232, through fluid conduit 226C, through metering valve 212C, through conduit 296, and to fluid tank 204.

When metering valve 212C is in the standby position, as illustrated, metering valve 212C connects fluid source 202, fluid tank 204, standby circuit 218, and power reclamation assembly 222 in the same manner as described above in relation to metering valve 212A, when metering valve 212A is in the standby position.

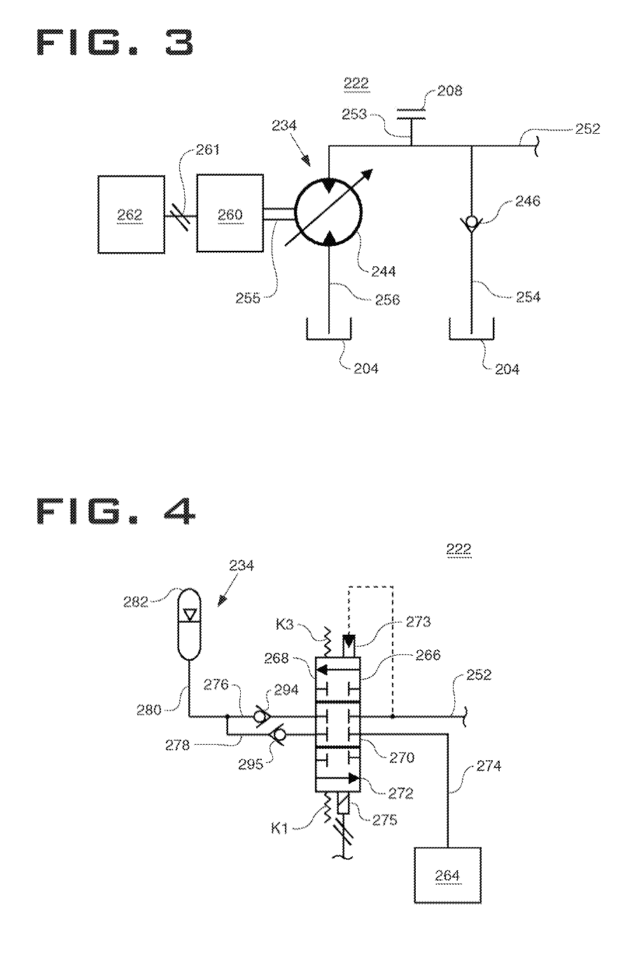

The power reclamation assembly 222 includes a power source 234 driven or charged by pressurized fluid flow from the standby circuit 216. The power reclamation assembly 222, as illustrated in FIG. 2, includes the power source 234, and check valve 246. The power source 234 includes a hydraulic motor 244. The hydraulic motor 244 has a first port and a second port and operates similarly to motor 232. Other, non-limiting, exemplary embodiments of power reclamation assembly 222 are illustrated in FIGS. 3-4.

Continuing in relation to FIG. 2, check valve 246 may include any device for limiting fluid flow to a single direction. Check valve 246 allows fluid flow from the fluid tank 204, through fluid conduits 254 and 252, to the motor 244; and prevents fluid flow from the motor 244 to the tank 204, through fluid conduits 252 and 254. When all the metering valves 212 are in an actuation position, fluid may be drawn from the tank 204 through fluid conduit 256 to the motor 244, as a result of churning in the tank 204. Check valve 246 and fluid conduit 254 allow any fluid drawn into the motor 244 in this manner to be returned to the tank 204.

Fluid conduit 252 connects the first port of motor 244 to standby fluid conduit 218. Fluid conduit 256 connects the second port of motor 244 to the fluid tank 204. The motor 244 selectively drives the engine 114 output through mechanical linkage 255. In an alternative embodiment, the motor 244 may drive another power output, non-limiting examples including the embodiment depicted in FIG. 3.

In the embodiment illustrated, standby circuit 216 includes the standby fluid conduit 218 and a pressure relief valve 220. Pressure relief valve 220 includes a pilot port, an input port, an output port, a first position and a second position. A K2 spring constant force biases the pressure relief valve 220 in the first position. A pressure exceeding a second predetermined value applied at the pilot port of pressure relief valve 220, overcomes the K2 spring force and moves the pressure relief valve 220 to the second position. Fluid conduit 250 connects standby fluid conduit 218 with the input port of pressure relief valve 220. Fluid conduit 251 connects the output port of pressure relief valve 220 to the fluid tank.

FIG. 2 shows the pressure relief valve 220 in the first position. When pressure relief valve 220 is in the first position, pressure relief valve 220 blocks fluid from flowing from stnadby fluid conduit 218, through fluid conduits 250 and 251, and to the tank 204. Instead, fluid flows through fluid conduit 252 to motor 244.

When the fluid pressure in standby fluid conduit 218 pressure exceeds the second predetermined value, pressure relief valve 220 moves to the second position, and fluid flows from the standby fluid conduit 218, through fluid conduit 250, through the pressure relief valve 220, and through fluid conduit 251 to the fluid tank 204. In alternative embodiments, fluid conduits 250 and 251, and pressure relief valve 220 may not be present, and all fluid from the standby fluid conduit 218 may flow through fluid conduit 252 to motor 244.

In the embodiment illustrated in FIG. 2, the motor 244 is shown as a variable displacement motor. In this embodiment, motor 244 may be controlled to act as a pump, if fluid source 202 is unable to meet the total power demand from all the actuation circuits 210. In this situation, motor 244 may act as a pump, drawing fluid from the tank 204 through fluid conduit 256, and pressurizing the fluid. The pressurized fluid may flow through fluid conduit 252, through fluid conduit 253 and to an actuation circuit 210 needing additional power. Additional elements symbol 208 indicates the valving that would be needed to implement this embodiment as would be known by an ordinary person skilled in the art now or in the future.

Referring now to FIG. 3, an alternative embodiment of the power reclamation assembly 222 is illustrated. This embodiment of the power reclamation assembly 222 includes the power source 234, the check valve 246, the fluid tank 204, fluid conduits 252, 253, 254, 256, and additional elements 208 as described in relation to FIG. 2. Instead of driving engine 114 through mechanical linkage 255, as in FIG. 2, the power source 234 in FIG. 3 drives an input shaft of a generator 260 through mechanical linkage 255. Generator 260 charges an electrical storage device 262 through an electrical connection 261. Electrical storage device 262 may include batteries, ultra-capacitors or other electrical storage devices known by an ordinary person skilled in the art now or in the future.

Referring now to FIG. 4, an alternative embodiment of the power reclamation assembly 222 is illustrated. This embodiment of the power reclamation assembly 222 includes the power source 234, and a directional control valve 266. The power source 234 illustrated in FIG. 4 includes a hydraulic accumulator 282 selectively charged by standby circuit 216 through fluid conduit 252, the directional control valve 266, and fluid conduits 276 and 280.

Directional control valve 266 includes a three position spring biased to closed position 270, directional valve, having a pilot port 273 fluidly connected to fluid conduit 252, and a solenoid actuator 275. Directional control valve includes a closed position 270, an accumulator charging position 268, and a accumulator discharge position 272.

When the fluid pressure in standby conduit 218 exceeds a first predetermined value, the first predetermined value less than the second predetermined value, pressure from fluid conduit 252 on pilot port 273 exceeds the K1 spring biasing force and directional control valve 266 moves to the accumulator charging position 268. Pressurized fluid from standby circuit 216 flows through fluid conduit 252, through directional control valve 266, through check valve 294, and through fluid conduits 276 and 280 to charge accumulator 282.

Stored power in accumulator 282 may drive other components in another hydraulic circuit 264. Directional control valve 266 moves to the accumulator discharge position 272 when sufficient electric current is applied to solenoid 275 to overcome both the K2 spring biasing force and the fluid pressure of standby fluid conduit 218 at pilot port 273. When directional control valve 266 moves to the accumulator discharge position 272, fluid from the accumulator 282 is discharged through fluid conduits 280 and 278, check valve 295, directional control valve 266, and fluid conduit 274 to another hydraulic circuit 264.

### INDUSTRIAL APPLICABILITY

Referring to FIG. 1 and FIG. 2, when an operator commands an action of the work implement system 122 on machine 100, through operator interface 112, he/she desires a prompt response. The operator commands are relayed from the operator interface 112, to the controller 116. The controller 116 relays electrical current to metering valves 212 to control actuators 228 to respond to the operator commands. Pressurized fluid flowing through a metering valve 212 to the standby circuit 216 when the metering valve is in the standby position, may assist in providing a rapid response of actuators 228 to an operator command, when the metering valve 212 moves to an actuating position.

Pressurized fluid from fluid source 202 will flow to standby fluid conduit 218 through any metering valve 212 in the standby position. Depending on fluid source 202 output pressure, how many metering valves 212 are in an actuating position, and the work being done by the actuators 228, the fluid flowing into standby fluid conduit 218 may include substantial energy available for storage or reuse. Pressurized standby fluid will then flow through standby fluid conduit 218 and fluid conduit 252, to motor 244. The output shaft of motor 244 will rotate in response to the pressurized fluid flowing into motor 244. Through mechanical linkage 255, power from motor 244 will be transmitted to the engine 114 output, or another power output.

If the fluid pressure in standby fluid conduit 218 exceeds a second predetermined value, standby fluid force on the pilot port of pressure relief valve 220 will exceed the K2 spring force and the pressure relief valve 220 will open. Standby fluid will flow through standby fluid conduit 218, through pressure relief valve 220, through fluid conduit 251 and to fluid tank 204. The K2 spring constant which biases pressure relief valve 220 to the closed position, may be set to a value to protect components in the standby circuit 216 and power reclamation assembly 222.

Referring to FIG. 3, power from motor 244 is transmitted through mechanical output 255 to a generator 260 input shaft. The generator 260 then charges electrical storage device 262 through electrical link 261.

Referring to FIG. 4, if the fluid pressure in standby fluid conduit 218 is above the first predetermined value, pressurized fluid at the pilot port 273 of directional control valve 266 will overcome the K1 spring force, moving the directional control valve 266 into the accumulator charge position 268. Pressurized fluid will then flow through standby fluid conduit 218, through fluid conduit 252, through directional control valve 266, through check valve 294, and through fluid conduits 276 and 280, to charge accumulator 282. When power stored in accumulator 282 is desired in another hydraulic circuit 264, controller 116 may provide enough electrical current at solenoid 275 to overcome both the K3 spring force and the fluid pressure in standby circuit 218, and the directional control valve 266 will move to the accumulator discharge position 272. Pressurized fluid from accumulator 282 will flow through fluid conduit 280, through fluid conduit 278, through check valve 295, through the direction control valve 266, and through fluid conduit 274 to the other hydraulic circuit 264.

From the foregoing it will be appreciated that, although specific embodiments have been described herein for purposes of illustration, various modifications or variations may be made without deviating from the spirit or scope of inventive features claimed herein. Other embodiments will be apparent to those skilled in the art from consideration of the specification and figures and practice of the arrangements disclosed herein. It is intended that the specification and disclosed examples be considered as exemplary only, with a true inventive scope and spirit being indicated by the following claims and their equivalents.

What is claimed is:

1. A hydraulic system, comprising:
a fluid source,
a metering valve including a standby position, and an actuation position different than the standby position,
an actuator fluidly connected to the fluid source when the metering valve is in the actuation position,
a power reclamation assembly fluidly connected to the fluid source when the metering valve is in the standby position.

2. The hydraulic system of claim 1,
further including a standby circuit,
and wherein the power reclamation assembly includes a power source and the standby circuit drives or charges the power source when the metering valve is in the standby position.

3. The hydraulic system of claim 1,
further including an actuator circuit, and
wherein the actuator circuit fluidly connects the actuator to the fluid source when the metering valve is in the actuating position.

4. The hydraulic system of claim 3, wherein the actuator includes a hydraulic cylinder assembly.

5. The hydraulic system of claim 3, wherein the actuator includes a hydraulic motor.

6. The hydraulic system of claim 1, wherein the power reclamation assembly includes a hydraulic motor.

7. The hydraulic system of claim 6, wherein the hydraulic motor includes a first port fluidly connected to a fluid tank; and a second port fluidly connected to the fluid tank through a check valve, and fluidly connected to the standby circuit.

8. The hydraulic system of claim 6, further comprising an engine including a power output, and wherein the hydraulic motor selectively drives the power output.

9. The hydraulic system of claim 6, wherein the power source includes an electric generator driven by the hydraulic motor.

10. The hydraulic system of claim 8, wherein the power source includes an electric storage device and the electric generator charges the electric storage device.

11. The hydraulic system of claim 1, further comprising an engine drivingly connected to the fluid source.

12. The hydraulic system of claim 2, further comprising a fluid tank, and a pressure relief valve fluidly connecting the standby circuit to the fluid tank when the pressure of fluid in the standby circuit is greater than a predetermined value.

13. The hydraulic system of claim 1, wherein the power reclamation assembly includes an accumulator.

14. The hydraulic system of claim 12, further including a hydraulic circuit selectively connected to the accumulator.

15. The hydraulic system of claim 1, wherein the fluid source includes a pump drivingly connected to an engine, and providing flow to the metering valve when the engine is running.

16. A hydraulic system, comprising:
a fluid source,
multiple metering valves, each metering valve including a standby position, and an actuation position different than the standby position,
multiple actuators, each actuator associated with one of the multiple metering valves and fluidly connected to the fluid source when the associated metering valve is in the actuation position,
a power reclamation assembly fluidly connected to the fluid source when at least one of the multiple metering valves is in the standby position.

17. A machine, comprising:
an engine,
an implement,
a fluid source driven by the engine,
a fluid tank,
a metering valve including a standby position, and an actuation position different than the standby position,
an actuator operably connected to the implement, and fluidly connected to the fluid source and the fluid tank when the metering valve is in the actuation position, and
a power reclamation assembly including a power source selectively drivingly connected to the engine, the power reclamation assembly fluidly connected to the fluid source when the metering valve is in the standby position.

18. An excavator, comprising:
a body,
a base,
a swing motor to rotate the body in relation to the base,
an engine,
a boom,
a stick,
a bucket,
a fluid source driven by the engine,
a fluid tank,
multiple metering valves, each metering valve including a standby position, and an actuation position different than the standby position,
multiple actuators, each actuator operably connected to one of the swing motor, the boom, the stick, and the bucket; associated with one of the multiple metering valves; and fluidly connected to the fluid source when the associated metering valve is in the actuation position,
a power reclamation assembly including a power source selectively drivingly connected to the engine, the power reclamation assembly fluidly connected to the fluid source when at least one of the multiple metering valves is in the standby position.
